(19) United States
(12) Patent Application Publication
(10) Pub. No.: US 2009/0073825 A1
(43) Pub. Date: Mar. 19, 2009

(54) Optical pick-up, aberration correcting method, optical pickup program, information recording device and method, information recording program, information reproducing device and method, information reproducing program, and information recording medium

(75) Inventor: Takuma Yanagisawa, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku, Tokyo (JP)

(21) Appl. No.: 11/918,886

(22) PCT Filed: Mar. 27, 2006
(86) PCT No.: PCT/JP2006/306130

§ 371 Date: Oct. 19, 2007

(30) Foreign Application Priority Data
Apr. 21, 2005 (JP) 2005-123694

(51) Int. Cl. G11B 7/00

(52) U.S. Cl. 369/44.23; G9B/7

(57) ABSTRACT

The invention is to provide an optical pickup capable of performing a track search operation accurately by reducing noise occurring in a focus servo system during the track search operation and also accurately recording/reproducing information to/from an optical disk.

An optical pickup PU for emitting a light beam B to an optical disk DK in which recording tracks having a land/groove structure are formed and receiving reflection light of the emitted light beam B, has: a liquid crystal panel 3 for correcting astigmatism included in light beam B by a cause peculiar to an optical system as a component of the optical pickup PU in a state where tracking servo is on, and correcting the astigmatism and a fundamental track crossing noise in a state where the tracking servo is off, and a liquid crystal panel control unit 8 for operating a liquid crystal panel 3 while making a switch in accordance with the state of the tracking servo.

### TECHNICAL FIELD

The present invention belongs to the technical fields of an optical pickup, an aberration correcting method, an optical pickup program, an information recording device and method, an information recording program, an information reproducing device and method, an information reproducing program, and an information recording medium. More particularly, the invention belongs to the technical fields of an optical pickup, an aberration correction method, and an optical pickup program having at least the function of correcting astigmatism which occurs due to a manufacture error of an optical part or the like in a light beam emitted to an optical recording medium such as an optical disk, an information recording device including the optical pickup and the like, an information recording method, and an information recording program, an information reproducing device including the optical pickup and the like, an information reproducing method, and an information reproducing program, and an information recording medium on which the program is recorded.

### BACKGROUND ART

In the case of optically recording/reproducing information by emitting a light beam to an optical recording medium such as an optical disk, generally, it is necessary to perform a control of making an information recording position in an information recording face of the optical recording medium and a focus position of the light beam coincide with each other. As the control, there are mainly two kinds of controls; focus servo of controlling a light condensing position in a direction perpendicular to the information recording face, and tracking servo of controlling a light condensing position (in other words, a light emission position in the information recording face of the light beam) in the direction parallel with the information recording face.

One of the methods in the focus servo is focus servo of the astigmatism method. The general focus servo of the astigmatism method will be described with reference to FIGS. 1A and 1B.

In the focus servo of the astigmatism method, a linearly polarized light beam emitted from a light source such as a semiconductor laser passes through a polarization beam splitter and is converted to a circularly polarized light beam by a λ/4 plate. The light beam further passes through an objective lens and forms a beam spot on an optical disk. Reflection light of the light beam from the optical disk passes again through the objective lens and is converted to a linearly polarized beam in the direction perpendicular to that of the incident light beam. The linearly polarized beam is guided by the polarization beam splitter to a condenser optical system. In the condenser optical system, a lens for condensing the reflection light and, simultaneously, giving astigmatism is disposed in the direction tilted by 45° with respect to a recording track of the optical disk. By reflection light which has passed through the lens, a circle C of least confusion is formed on the light reception face of a detector D divided in four parts as shown in FIG. 1A.

When the distance between the objective lens and the optical disk is ideal, the circle C of least confusion on the detector D is almost completely round. The value of a focus error signal FES output as the difference of sum signals of divided detectors in the positions facing each other on the detector D (in the case of FIG. 1A, the value of FES=(Da+Dc)−(Db+Dd)) is “0”.

On the other hand, when the distance between the objective lens and the optical disk is not ideal, the shape of the circle C of least confusion on the detector D is an ellipse. According to the distance between the objective lens and the optical disk, the tilt of the ellipse changes as shown in FIG. 1A. Therefore, when the horizontal axis indicates the distance between the objective lens and the optical disk and the vertical axis indicates the magnitude of the focus error signal FES, the waveform of the focus error signal FES becomes waveform as shown in FIG. 1B. The curve as the waveform of the focus error signal FES is generally called an “S curve”. In the focus servo of the astigmatism method, by moving the objective lens in the direction perpendicular to the optical disk (that is, the direction parallel with the optical axis of the light beam) so that the value of the focus error signal FES becomes “0”, the focus servo is executed.

As described above, in the focus servo of the astigmatism method, the distance between the objective lens and the optical disk is determined using the value of the focus error signal and, on the basis of the value, the objective lens is moved in the direction perpendicular to the optical disk. Consequently, it is necessary to minimize occurrence of an error in the focus error signal due to, for example, noise which occurs in the focus error signal itself.

One of noises found to be added from the outside to the focus error signal is so-called track crossing noise which occurs when a light beam is emitted to an optical disk having the land/groove structure. The track crossing noise is noise added to the focus error signal when a beam spot on an optical disk is moved across the land track and the groove track in the radial direction at the time of, for example, a so-called track search.

It has been known that one of causes of the track crossing noise is a manufacture error of an optical system including an objective lens.

Specifically, in the case where astigmatism in the direction of 45° with respect to each of the tracks parallel to each other remains due to the manufacture error in an optical system in an outgoing path of a light beam from a light source to an optical disk, when the intensity distribution of reflection light of a light beam reflected/diffracted by the optical disk is observed on an objective lens, generally, the intensity distribution on the land track and that on the groove track formed on the optical disk as shown in FIG. 2 are antisymmetric. The track crossing noise due to the manufacture error occurs in the focus error signal obtained by receiving reflection light, caused by the fact that the intensity distribution on the land track and that on the groove track are antisymmetric.

Some methods of reducing the track crossing noise caused by the difference in the intensity distributions have been proposed. One of them is disclosed in Japanese Patent Application Laid-Open (JP-A) No. 2000-40249.

In the method disclosed in JP-A No. 2000-40249, a liquid crystal panel is inserted between an objective lens and a light source. Pseudo astigmatism is generated by the liquid crystal panel to cancel out astigmatism caused by a manufacture error in an optical system, thereby reducing track crossing noise caused by an aberration in an outgoing path.

On the other hand, in recent years, an optical disk with improved recording density (hereinbelow, called a high-recording-density optical disk) is being developed, by shortening the wavelength of a light beam for recording/reproduction of a CD (Compact Disc) or a DVD (Digital Versatile Disc) generally used at present. In the high-recording-density optical disk, the interval between tracks is narrower than that in the DVD and the distance between the surface of an optical disk and a recording layer is shorter than that of the DVD. Consequently, the capture range (see FIG. 1B) in the S curve has to be much narrower than that in the case of the DVD.

### DISCLOSURE OF THE INVENTION

### Problems to be Solved by the Invention

However, in studies in recent years of the inventors of the present invention, it was found that when the capture range in an optical disk having the land/groove structure is made narrower than the capture range at present, track crossing noise which cannot be reduced or eliminated even by the method disclosed in JP-A No. 2000-40249 occurs. Due to the track crossing noise, noise in the focus error signal in the high-recording-density optical disk increases. As a result, a problem occurs such that the operation such as a track search cannot be performed accurately.

The present invention has been achieved in consideration of the problem, and an object of the invention is to provide an optical pickup capable of performing a track search operation accurately by reducing noise occurring in a focus servo system during the track search operation and also accurately recording/reproducing information to/from an optical disk, an aberration correcting method, an optical pickup program, an information recording device including the optical pickup, an information recording method, an information recording program, an information reproducing device including the optical pickup, an information reproducing method, an information reproducing program, and an information recording medium on which the program is recorded.

### Means for Solving the Problem

To achieve the object, the invention of claim 1 provides an optical pickup for emitting a light beam to an optical recording medium in which recording tracks having a land/groove structure are formed and receiving reflection light from the optical recording medium of the emitted light beam, including: first correcting means such as a liquid crystal panel for correcting astigmatism included at least in the reflection light caused by a cause peculiar to an optical system as a component of the optical pickup in a state where tracking servo is on, the tracking servo for controlling a position on the optical recording medium, of a light spot formed on the recording track by the emission of the light beam and a position of the recording track; second correcting means such as a liquid crystal panel, when the tracking servo is off, for correcting the astigmatism and cancelling out noise included in the reflection light and received caused by the difference between a phase distribution in the light spot on the land and the phase distribution on the groove when the light spot continuously moves across the land and the groove; and control means such as a liquid crystal panel control unit for operating the first and second correcting means while making a switch between the first and second correcting means in accordance with the state of the tracking servo.

To achieve the object, the invention of claim 6 provides an information recording device for optically recording information on the optical recording medium in any of claims 1 to 5, including: the optical pickup according to any one of claims 1 to 5; servo control means such as a tracking control unit for turning on the tracking servo; and modulating means such as a recording processing unit for modulating the light beam in the on state in correspondence with the recording information and emitting the modulated light beam to the light recording medium.

To achieve the object, the invention of claim 7 provides an information reproducing device for optically reproducing reproduction information recorded on the optical recording medium in any of claims 1 to 5, including: the optical pickup according to any one of claims 1 to 5; servo control means such as a tracking control unit for turning on the tracking servo; and reproducing means such as a reproduction processing unit for receiving the reflection light of the light beam in the on state emitted to the optical recording medium and reproducing the reproduction information.

To achieve the object, the invention of claim 8 provides an aberration correcting method executed in an optical pickup of emitting a light beam to an optical recording medium such as an optical disk in which recording tracks having a land/groove structure are formed and receiving reflection light from the optical recording medium of the emitted light beam, including: a first correcting step of correcting astigmatism included at least in the reflection light caused by a cause peculiar to an optical system as a component of the optical pickup in a state where tracking servo is on, the tracking servo for controlling a position on the optical recording medium, of a light spot formed on the recording track by the emission of the light beam and a position of the recording track; and a second correcting step of correcting the astigmatism when the tracking servo is off, and cancelling out noise included in the reflection light and received due to the difference between a phase distribution in the light spot on the land and a phase distribution on the groove when the light spot continuously moves across the land and the groove.

To achieve the object, the invention of claim 9 provides an information recording method for optically recording information on the optical recording medium in claim 8, wherein in the case of recording the recording information onto the optical recording medium, a servo-on control step of turning on the tracking servo, the first correcting step in claim 8, and a modulating step of modulating the light beam in the on state in correspondence with the recording information and emitting the modulated light beam to the optical recording medium are executed, and in the case of executing a track search for retrieving the recording track on the optical recording medium, a servo-off control step of turning off the tracking servo, the second correcting step in claim 8, and a search step of executing the track search during execution of the second correcting step are executed.

To achieve the object, the invention of claim 10 provides an information reproducing method for optically reproducing reproduction information recorded on the optical recording medium in claim 8, wherein in the case of reproducing the reproduction information from the optical recording medium, a servo-on control step of turning on the tracking servo, the first correcting step in claim 8, and a reproducing step of receiving the reflection light of the light beam in the on state reflected by the optical recording medium and reproducing the reproduction information are executed, and in the case of executing a track search for retrieving the recording track on the optical recording medium, a servo-off control step of turning off the tracking servo, the second correcting step in claim 8, and a search step of executing the track search during execution of the second correcting step are executed.

To achieve the object, the invention of claim 11 makes a control computer included in the optical pickup according to any one of claims 1 to 5 function as the control means in any of claims 1 to 5.

To achieve the object, the invention of claim 12 makes a recording computer included in the information recording device in claim 6 function as: the control means as a component of the optical pickup of claim 7; the servo control means; and the modulating means.

To achieve the object, the invention of claim 13 makes a reproduction computer included in the information reproducing device in claim 7 function as: the control means as a component of the optical pickup of claim 7; the servo control means; and the reproducing means.

To achieve the object, in the invention of claim 14, the optical pickup program of claim 11 is recorded so that it can be read by the control computer.

To achieve the object, in the invention of claim 15, the information recording program of claim 12 is recorded so that it can be read by the recording computer.

To achieve the object, in the invention of claim 16, the information reproduction program of claim 13 is recorded so that it can be read by the reproduction computer.

### BRIEF DESCRIPTION OF DRAWINGS

FIGS. 1A and 1B are diagrams illustrating a conventional focus servo operation. FIG. 1A is a diagram showing circles of least confusion and FIG. 1B is a diagram showing an S curve.

FIG. 2 is a diagram showing track crossing noise caused by a manufacture error.

FIG. 3 is a diagram (I) for explaining the principle of the fundamental track crossing noise.

FIG. 4 is a diagram (II) for explaining the principle of the fundamental track crossing noise.

FIG. 5 is a diagram (III) for explaining the principle of the fundamental track crossing noise.

FIG. 6 is a diagram (IV) for explaining the principle of the fundamental track crossing noise.

FIG. 7 is a block diagram showing a schematic configuration of an optical pickup in the embodiment.

FIG. 8 is a plan view showing the structure of a electrode of a liquid crystal panel in the embodiment.

FIGS. 9A and 9B are diagrams for explaining cancellation of track crossing noise caused by a manufacture error. FIG. 9A is a diagram illustrating the principle of the cancellation, and FIG. 9B is a diagram illustrating the relation between an actual drive voltage and phase difference given.

FIG. 10 is a diagram illustrating drive voltages in the embodiment.

FIG. 11 is a diagram illustrating astigmatism necessary to cancel off fundamental track crossing noise.

FIG. 12 is a flowchart showing operation of the optical pickup in the embodiment.

FIGS. 13A and 13B are flowcharts showing processes for determining drive voltages in the embodiment. FIG. 13A is a flowchart showing processes for determining drive voltages used at the time of recording/reproducing information, and FIG. 13B is a flowchart showing processes for determining drive voltages used for a track search.

FIG. 14 is a block diagram showing a schematic configuration of an information recording device including the optical pickup in the embodiment.

FIG. 15 is a block diagram showing a schematic configuration of the information reproducing device including the optical pickup in the embodiment.

### DESCRIPTION OF REFERENCE NUMERALS

1 light source
2 polarization beam splitter
3 liquid crystal panel
λ/4 plate
5 tracking actuator
6 objective lens
7 tracking control unit
8 liquid crystal panel control unit
9 multi-lens
10 spindle motor
11 disk determining circuit
12 focus control unit
20 recording processing unit
30 transparent electrode
30A, 30B, 30C, 30D, 30E partial electrode
40 reproduction processing unit
D detector

### BEST MODES FOR CARRYING OUT THE INVENTION

Best modes for carrying out the invention will now be described with reference to the drawings. The following embodiments relate to the case of applying the present invention to an optical pickup for recording/reproducing information to/from both of the DVD and the high-recording-density optical disk, or an information recording device or an information reproducing device including the optical pickup.

### (I) PRINCIPLE OF THE INVENTION

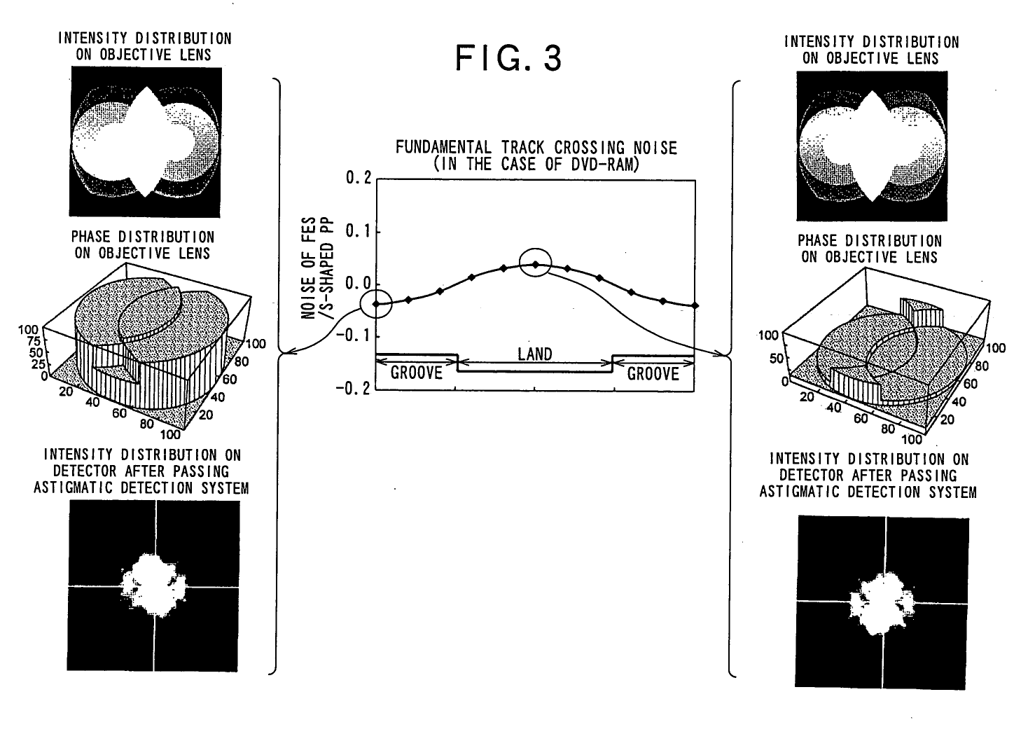

Prior to concrete description of an embodiment of the present invention, first, the principle of the invention will be described with reference to FIGS. 3 to 6. Each of FIGS. 3 to 6 is a diagram for concretely explaining the principle.

As described above, the inventors of the present invention found out that by making the capture range of a focus error signal in an optical disk having a land/groove structure narrower than that for a DVD, track crossing noise which cannot be reduced or prevented even by the method disclosed in JP-A No. 2000-40249 (hereinbelow, the newly found track crossing noise will be called fundamental track crossing noise).

FIG. 3 shows an experimental result of simulation of a state of generation of a focus error signal (expressed as “FES” in FIG. 3) of an astigmatism method in a conventional DVD-RAM (DVD-Random Access Memory) having the land/groove structure. In the experiment, the distance between an objective lens and an optical disk is always an optimum value. The horizontal axis of a graph shown in the center of FIG. 3 indicates the position of a beam spot on an optical disk, and the vertical axis indicates a value obtained by normalizing a focus error signal with a PP (Peak to Peak) value of an S curve. Contour graphs (in upper left and right graphs in FIG. 3) on both sides of the graph and three-dimensional graphs (in the center of the left part and the center of the right part of FIG. 3) show intensity distributions and phase distributions when a light beam reflected/diffracted by a land track (the right in FIG. 3) or a groove track (the left in FIG. 3) of the optical disk is observed on the objective lens and the detector.

As obvious from FIG. 3, the intensity distribution on the objective lens when a groove track is irradiated with a light beam on an optical disk and that when a land track is irradiated with a light beam is completely equal to each other (see the upper right and left graphs in FIG. 3). However, the intensity distributions on the detector that receives reflection light of the light beams are slightly different from each other (see the lower right and left graphs in FIG. 3). As a result of the difference, irrespective of the fact that focus is achieved on the land track or the groove track, the values of the focus error signals do not become “0”. The cause is considered that the phase distribution on the groove track and that on the land track as shown in the center of the left part of FIG. 3 and the center of the right part of FIG. 3 are largely different from each other due to interference of reflection light of the optical beams reflected/diffracted on the optical disk.

Therefore, when the beam spot on the optical disk is moved in the radial direction in, for example, a track search or the like, due to the difference between the intensity distributions shown in the right and left lower graphs of FIG. 3, large noise occurs in the focus error signal. The cause is that the frequency when the irradiation position on an optical disc moves from a land track to a groove track (or from a groove track to a land track) in a track search is generally higher than a frequency band of focus servo of moving an objective lens in the optical axis direction. The track crossing noise included in a focus error signal due to the phenomenon shown in FIG. 3 is the above-described fundamental track crossing noise. When the fundamental track crossing noise occurs in the track search, accurate focus servo cannot be executed. As a result, an accurate track search cannot be executed.

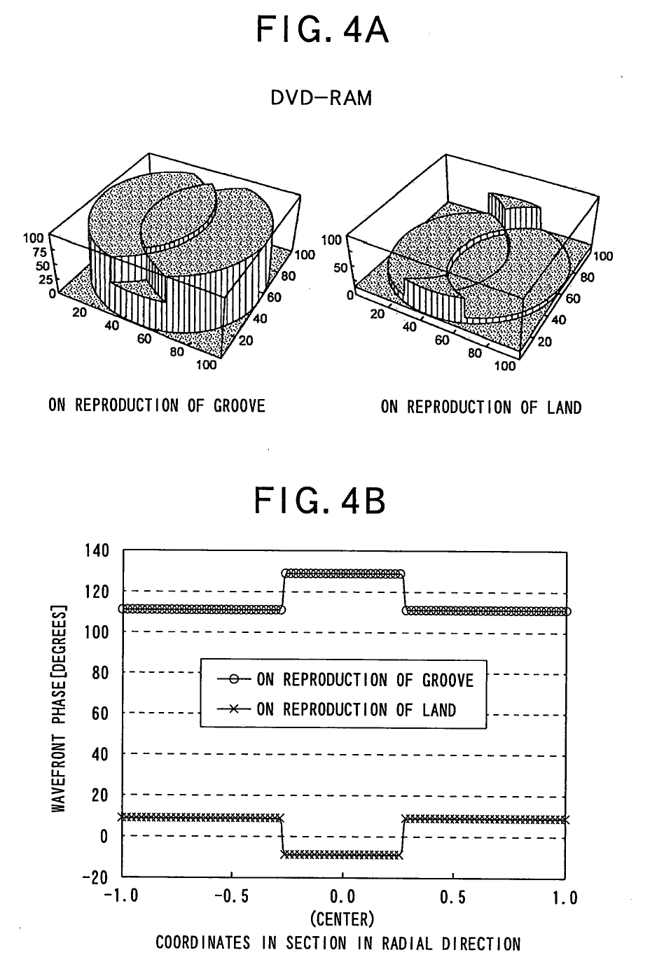

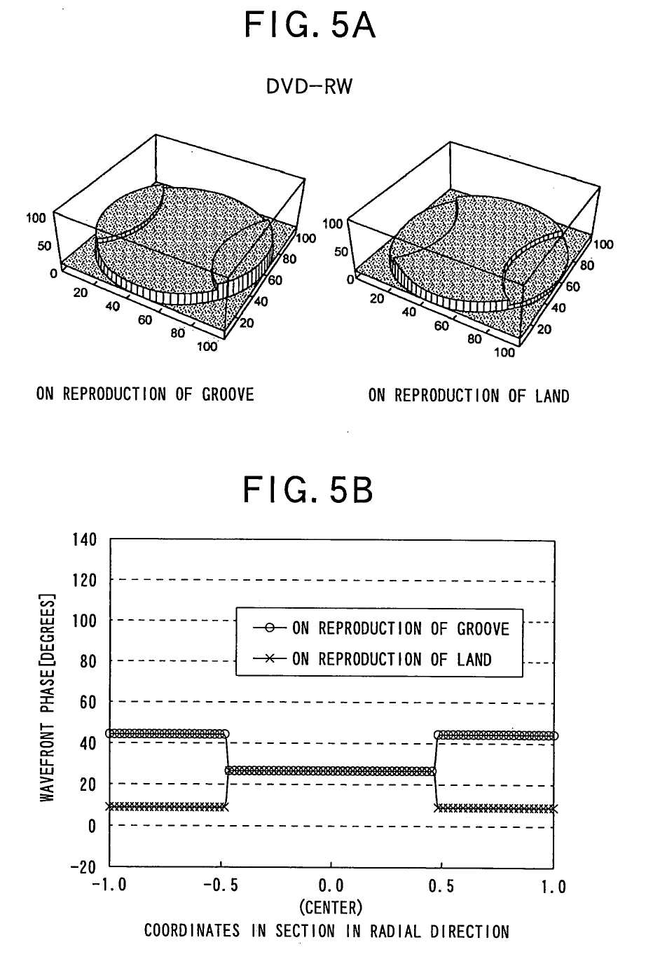

The phase distribution on the objective lens shown in the center in the left part of FIG. 3 and that in the center in the right part of FIG. 3 will be described more concretely. The phase distribution when an optical beam reflected and diffracted by a groove track on a conventional DVD-RAM and that when an optical beam reflected and diffracted by a land track in a manner similar to the case of FIG. 3 are as shown in the left and right parts, respectively, of FIG. 4A (which are the same as the phase distributions in the center in the left part and the center in the right part in FIG. 3). The concrete difference between wavefront phases is as shown in FIG. 4B. On the other hand, different from the case of FIG. 3, the phase distribution when an optical beam reflected and diffracted by a groove track on a conventional DVD-RW (DVD-ReRecordable) and that when an optical beam reflected and diffracted by a land track are as shown in the left and right parts, respectively, of FIG. 5A. The concrete difference between wavefront phases is as shown in FIG. 5B.

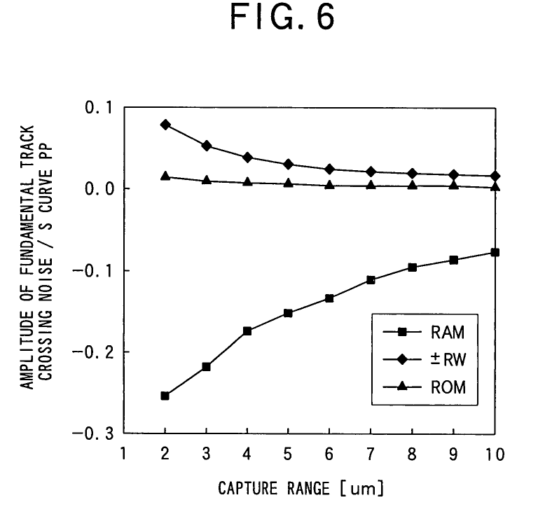

As obvious from FIG. 5 and FIG. 6 showing the relation between the capture range and the fundamental track crossing noise by kinds of optical disks, the fundamental track crossing noise depends on the structure of an optical disk (more concretely, the track pitch, the width or height (depth) of a groove track, or the like) and parameters of an optical system for detecting astigmatism. The smaller the astigmatism amount added to the optical system is or the narrower the capture range is, the larger the amplitude of the fundamental track crossing noise is.

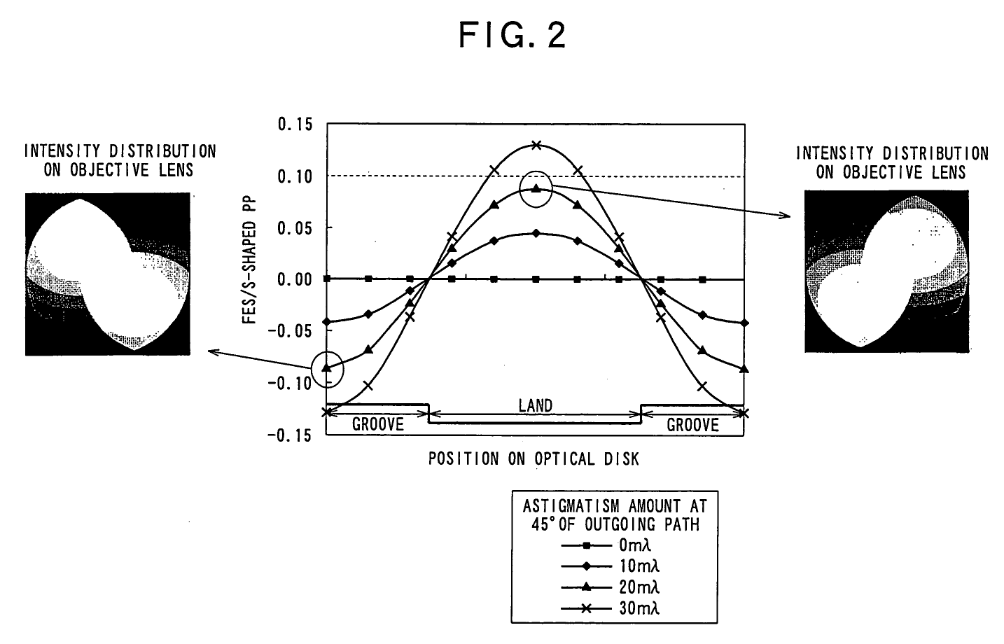

The inventors of the present invention who found existence of the fundamental track crossing noise separately from track crossing noise caused by a manufacture error described with reference to FIG. 2 focuses on, not correction of astigmatism, removal of general track crossing noise including the astigmatism at the time of track search. On the other hand, at the time of recording/reproducing information to/from an optical disk, the inventors focus on correction of astigmatism caused by a manufacture error like the conventional technique, to control drive voltage in a liquid crystal panel giving astigmatism to a light beam.

### (II) EMBODIMENTS

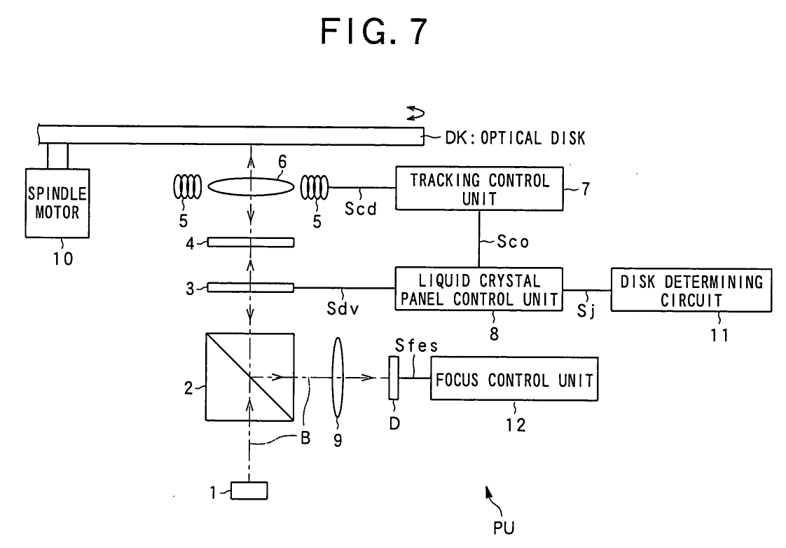

(II) Next, embodiments of the invention based on the principle will be described concretely with reference to FIGS. 7 to 13.

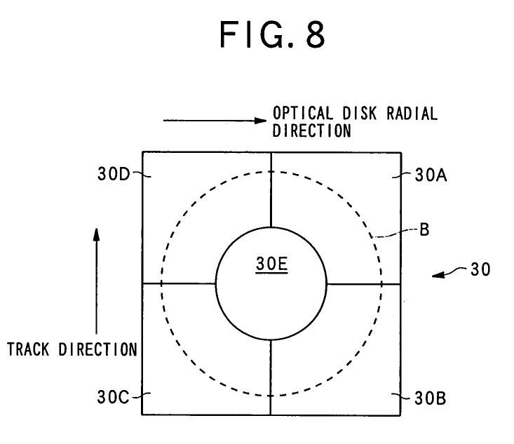

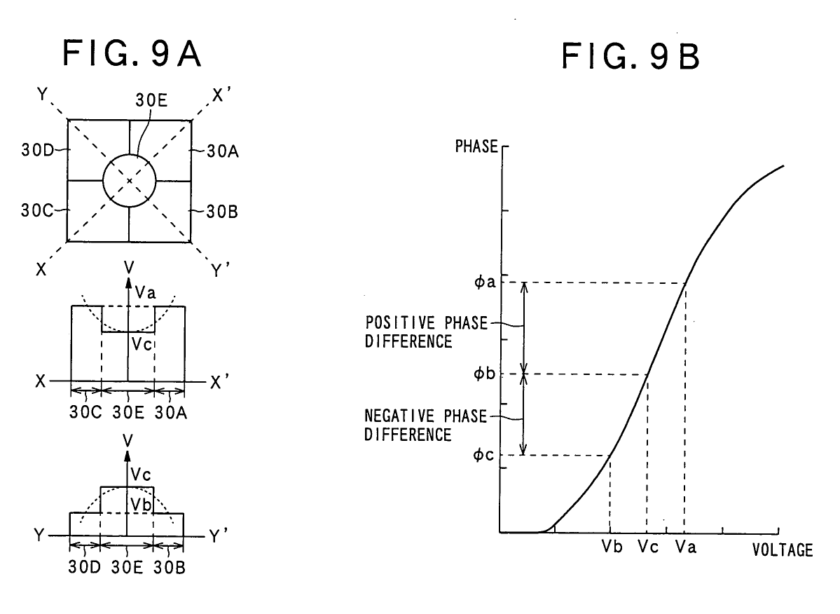

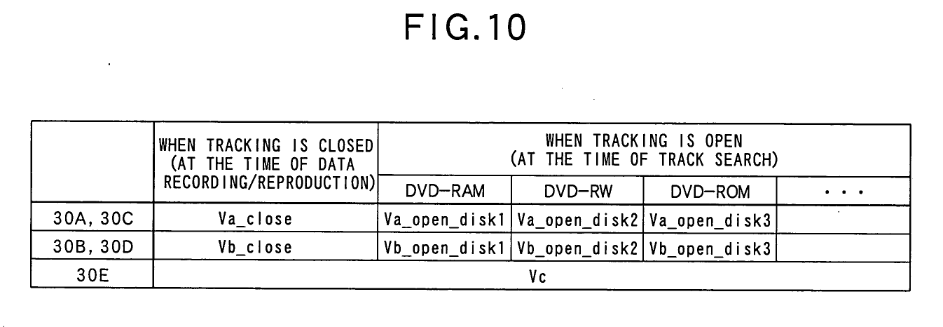

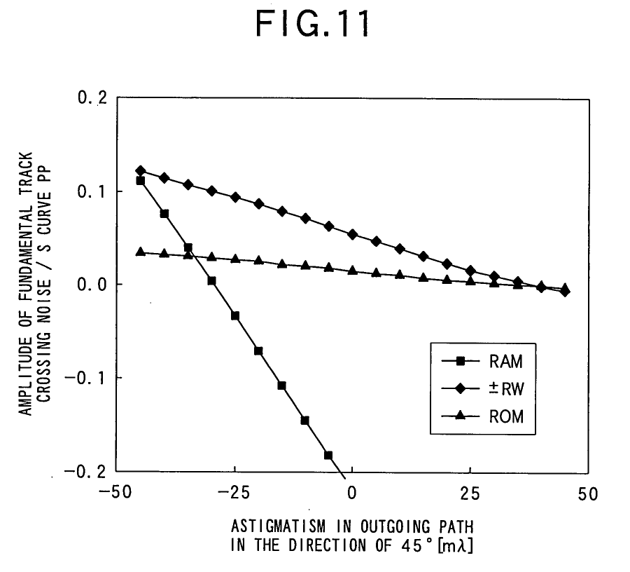

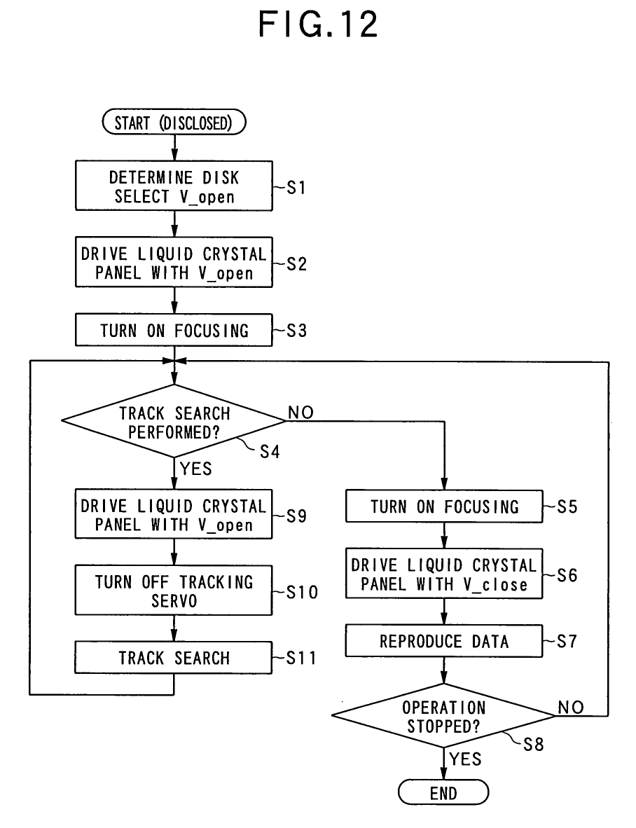

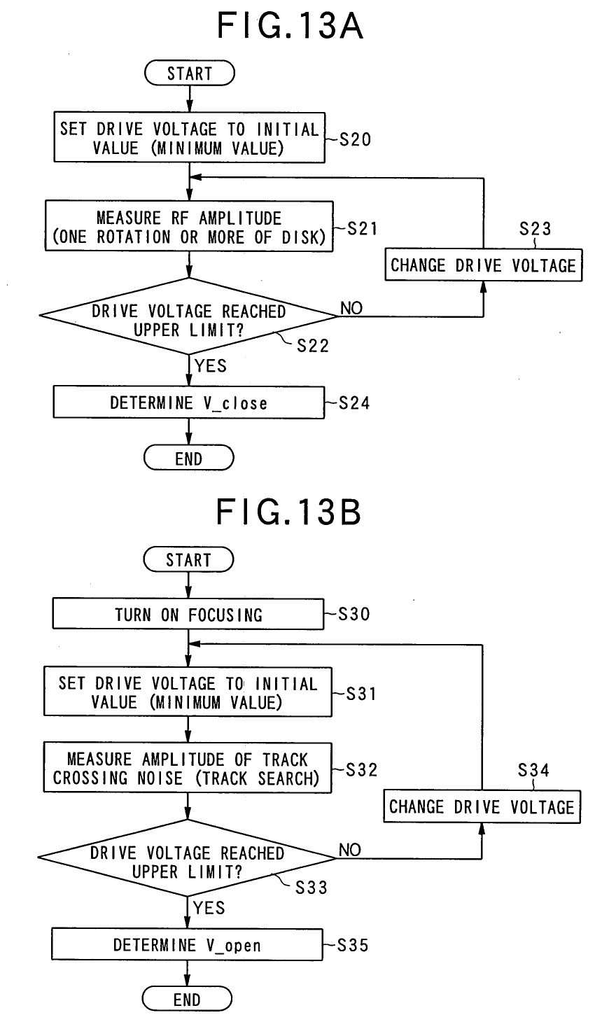

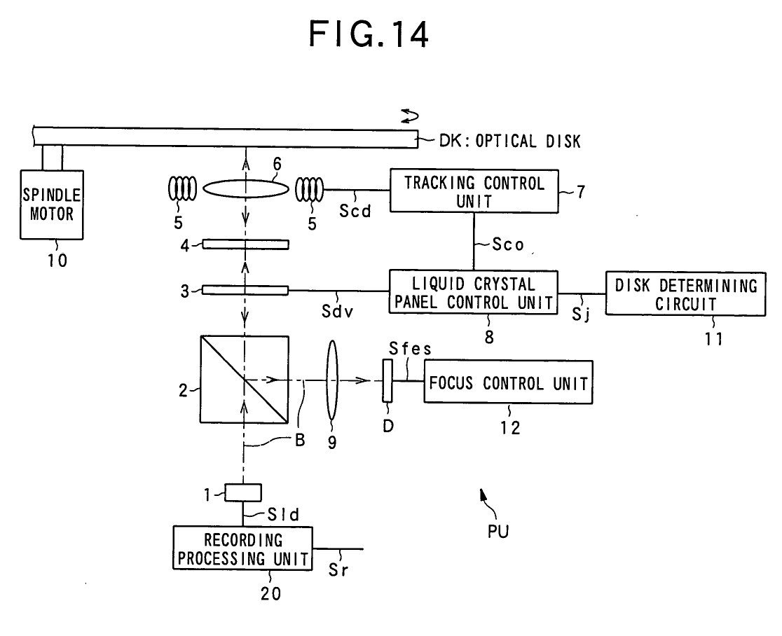

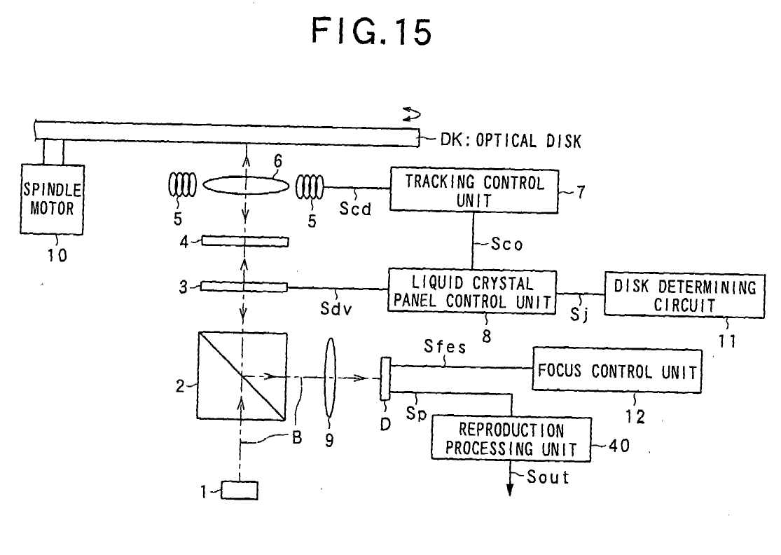

FIG. 7 is a block diagram showing a schematic configuration of an optical pickup as an embodiment. FIG. 8 is a plan view showing a schematic configuration of an electrode of a liquid crystal panel in the embodiment. FIGS. 9A and 9B are diagrams for explaining quasi astigmatism to be added to a light beam by the liquid crystal panel. FIG. 10 is a diagram illustrating a method of driving the liquid crystal panel. FIG. 11 is a diagram illustrating drive voltages for a liquid crystal panel of the embodiment. FIG. 12 is a flowchart showing operation of the optical pickup in the embodiment. FIGS. 13A and 13B are flowcharts showing processes for determining drive voltages in the embodiment. FIG. 14 is a block diagram showing a schematic configuration of an information recording device including the optical pickup in the embodiment. FIG. 15 is a block diagram showing a schematic configuration of the information reproducing device including the optical pickup in the embodiment.

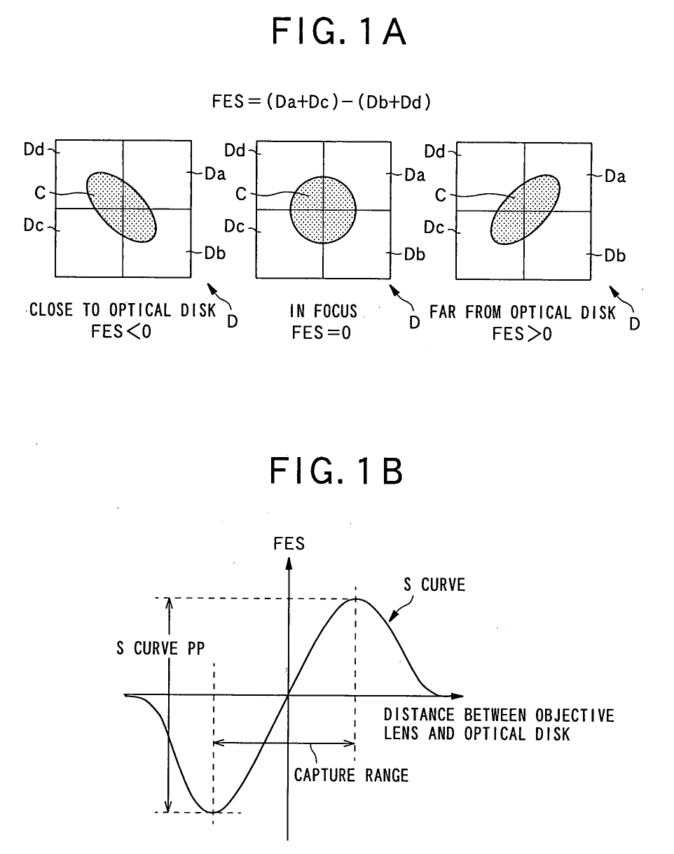

As shown in FIG. 7, an optical pickup PU as an embodiment includes a light source 1, a polarization beam splitter 2, a liquid crystal panel 3 as first and second correcting means, a λ/4 plate 4, an objective lens 6 fixed to a tracking actuator 5, a multi-lens 9 having an astigmatism adding function and a light condensing function, a detector D having a configuration similar to that shown in FIG. 1, a tracking control unit 7 as servo control means, a liquid crystal panel control unit 8 as control means, an optical disk determining circuit 11, and a focus control unit 12.

The light source 1, the polarization beam splitter 2, the λ/4 plate 4, the objective lens 6, and the multi-lens 9 are optical parts. The tracking control unit 7, the liquid crystal panel control unit 8, the optical disk determining circuit 11, and the focus control unit 12 are mainly constructed by electronic circuits.

The general operation of the optical pickup PU will now be described.

In the case of optically reproducing information recorded on an optical disk DK (such as a DVD-RAM or DVD-RW having the land/groove structure) fixed to a spindle motor 10 and rotated, or in the case of optical recording the information to the optical disk DK, the light source 1 in the optical pickup PU emits a light beam B having preset intensity in a linearly polarized state. The light beam B passes through the polarization beam splitter 2 and is applied on the liquid crystal panel 3.

The liquid crystal panel 3 has a configuration in which an alignment layer, a transparent electrode, a protection layer, and the like are stacked in order from the position close to the liquid crystal on both sides of a liquid crystal while sandwiching the liquid crystal. Each of the transparent electrode, as a transparent electrode 30 shown in the plan view of FIG. 8 (plan view of a plane perpendicular to the optical axis of the light beam B), is divided into five partial electrodes 30A to 30E using the optical axis of the light beam B as a center (the irradiation range of the light beam B in the transparent electrode 30 is expressed by reference character “B” in FIG. 8). The division lines of the partial electrodes 30A to 30E and the radial direction and the track direction of the track direction have the relations shown in FIG. 8. To the partial electrodes 30A to 30E, drive voltages independent of each other are applied in accordance with a control signal Sdv from the liquid crystal panel control unit 8. To the light beam B passing through the transparent electrodes 30, phase differences which are various among parts of a light flux section of the light beam B passing through the areas of the partial electrodes 30A to 30E are added.

Referring again to FIG. 7, the light beam B to which the phase differences are added in the areas corresponding to the partial electrodes 30A to 30E by the liquid crystal panel 3 passes through the λ/4 plate 4, thereby being converted from a linearly polarized state to a circular polarized state. The light beam B is condensed on a not-shown information recording surface in the optical disk DK by the objective lens 6 and is reflected.

Next, the reflected light beam B in a state where the direction of the circular polarization becomes opposite passes through the objective lens 6, and the circularly polarization state is reset to the linear polarization state by the λ/4 plate 4. The reset orientation of the linear polarization is turned from the direction of the linear polarization of the light beam B emitted from the light source 1 by 90°.

The light beam B in the linear polarization state passes again through the liquid crystal panel 3 so that phase differences are added again to the areas corresponding to the partial electrodes 30A to 30E. The resultant light beam is reflected by the polarization beam splitter 2 and enters the multi-lens 9. The reason why the light beam B is reflected by the polarization beam splitter 2 is that, as described above, the polarization direction in the circular polarization becomes opposite by the reflection in the information recording surface of the optical disk DK and, further, the orientation of the linear polarization is turned from that emitted from the light source 1 by 90°.

Next, the multi-lens 9 adds astigmatism for focus servo by the astigmatism method to the incident light beam B and condenses the light beam B onto the detector D. A circle C of least confusion generated on the detector D by the condensing is as shown in FIG. 1A.

Consequently, from the detector D, the focus error signal Sfes (see FIG. 1) output as the difference of sum signals of division detectors in positions facing on the detector D is generated and output to the focus control unit 12. The focus control unit 12 makes a not-shown focus actuator move the objective lens 6 in a direction perpendicular to the optical disk DK on the basis of the focus error signal Sfes, thereby executing necessary focus servo at the time of recording/reproduction of information.

On the other hand, the tracking control unit 7 drives the tracking actuator 5 by using a drive signal Scd, thereby executing necessary tracking at the time of recording/reproducing information, and outputs a servo state signal Sco indicating that a servo loop in the tracking servo is in a closed state (in other words, a state of recording/reproducing information to/from the optical disk DK) or an open state (in other words, a track search state) to the liquid crystal panel control unit 8.

On the other hand, the optical disk determining circuit 11 determines, for example, the kind of the optical disk DK (more concretely, for example, a DVD-RAM, a DVD-RW, or a DVD-ROM) by a conventional method using, for example, an optical detector. The optical disk determining circuit 11 generates a kind signal Sj indicative of the determined kind and outputs it to the liquid crystal panel control unit 8.

On the basis of the servo state signal Sco and the kind signal Sj, the liquid crystal panel control unit 8 generates the control signal Sdv and drives each of the partial electrodes 30A to 30E in the liquid crystal panel 3 to control the drive voltage in the liquid crystal panel 3 at the time of recording/reproducing information to/from the optical disk DK and at the time of a track search.

Next, the drive modes of the liquid crystal panel 3 by the liquid crystal panel control unit 8 will be described more concretely with reference to FIGS. 9 to 11.

First, drive modes of the liquid crystal panel 3 at the time of recording/reproducing information to/from the optical disk DK (that is, when the tracking servo loop is closed) will be described.

At the time of recording/reproducing the information, the liquid crystal pane 3 displays the function of giving the pseudo astigmatism for cancelling out the astigmatism caused by the manufacture error of the optical system.

Consequently, as shown in the upper and intermediate parts of FIG. 9A, a drive voltage Va higher than a drive voltage Vc applied to the partial electrode 30E, as a center, disposed in the center of the transparent electrode 30 is applied to the partial electrodes 30A and 30C. Concurrently, as shown in the upper and lower parts of FIG. 9A, a drive voltage Vb lower than the drive voltage Vc is applied to the partial electrodes 30B and 30D. In the intermediate and lower parts of FIG. 9A, the pseudo astigmatism actually given to the light beam B in order to cancel off the astigmatism caused by a manufacture error in the optical system is illustrated by dot lines.

As concrete values of the drive voltages Va to Vc, as shown in FIG. 9B, a drive voltage for applying a positive phase difference using, as “0” the phase difference added by the partial electrode 30E to which the drive voltage Vc is applied is set as the drive voltage Va, and a drive voltage for applying a negative phase difference is set as the drive voltage Vb. With the drive voltages, the partial electrodes 30A to 30C are driven.

The drive mode of the liquid crystal panel 3 shown in FIGS. 9A and 9B is the same, in theory, as that described in the columns [0034] to [0088] of the JP-ANo. 2000-40249 and shown in FIGS. 1 to 10.

On the other hand, at the time of performing a track search on the optical disk DK (that is, when the tracking servo loop is open), the liquid crystal panel 3 displays the function of giving the pseudo astigmatism for cancelling off the two track crossing noises each other to the light beam B.

With respect to the drive voltages Va to Vc applied to the partial electrodes 30A to 30E, as shown in FIG. 10, although the drive voltage Vc applied to the partial electrode 30E is the same as that when the tracking servo loop is closed, the drive voltages applied to the set of the partial electrodes 30A and 30C and the set of the partial electrodes 30B and 30D are the same in each of the sets. The drive voltages are pre-set according to the kind of the optical disk DK set by set.

Specifically, as shown in FIG. 10, at the time of the track search, in a manner similar to the case shown in FIG. 9, the set of the partial electrodes 30A and 30C and the set of the partial electrodes 30B and 30D are driven by different drive voltages. The drive voltages are preliminarily determined according to the kinds of the optical disk DK determined by the optical disk determining circuit 11. As shown in FIG. 11, the phase difference necessary to cancel off the fundamental track crossing noise varies according to the kind. Consequently, the drive voltages by the kinds are determined in advance by the kinds as drive voltages each necessary to add a phase difference capable of cancelling off both of the fundamental track crossing noise in the optical disk DK of the kind and the track crossing noise caused by a manufacture error. The value of the pre-determined drive voltage itself is stored in a nonvolatile manner together with the value of a drive voltage used at the time of recording/reproducing information shown in FIG. 9, into a not-shown memory in the liquid crystal panel control unit 8. FIG. 11 is a diagram illustrating an astigmatism amount of an outgoing path necessary to cancel out the fundamental tracking crossing noise in the case of reproducing information from various kinds of optical disks DK when the capture range of the optical pickup PU is 3.0 μm.

In the example of FIG. 10, for example, when the optical disk DK is a DVD-RAM, the value of the drive voltage Va applied to the partial electrodes 30A and 30C is the value stored as “Va_open_disk1” in the memory. The value of the drive voltage Vb applied to the partial electrodes 30B and 30D is the value stored as “Vb_open_disk1” in the memory. The value of the drive voltage Vc applied to the partial electrode 30E is the value stored as the same value “Vc” as that in the case of recording/reproducing information shown in FIG. 9 in the memory.

Next, the operation for eliminating the track crossing noise executed in the optical pickup PU having the configuration described by referring to FIGS. 7 to 11 will be described in short in time series with reference to FIG. 12.

As shown in FIG. 12, in the operation of eliminating the track crossing noise in the embodiment, when the optical disk DK is loaded and fixed to the spindle motor 10, the kind of the optical disk is determined by the optical disk determining circuit 11. Since the tracking servo loop is open at present, as the drive voltages applied to the partial electrodes 30A to 30D, drive voltages corresponding to the kinds of the optical disk DK determined and applied when the tracking servo loop is open are selected (step S1). By using the selected drive voltages, the liquid crystal panel 3 is driven (step S2).

Next, while applying the drive voltages, the focus servo loop is set in the close state (step S3) and, further, whether the track search operation is performed or not is checked on the basis of an instruction operation from the user or the like (step S4). When the track search operation is not performed (NO in step S4), the tracking servo loop is closed on assumption that information on the optical disk DK loaded at that time is reproduced (step S5). As the drive voltages applied to the partial electrodes 30A to 30D, the drive voltages at the time of recording/reproducing information (in the case of FIG. 10, the drive voltage applied to the partial electrodes 30A and 30C is “Va_close”, the drive voltage applied to the partial electrodes 30B and 30D is “Vb_close”, and the drive voltage applied to the partial electrode 30E is “Vc”) are set to drive the liquid crystal panel 3 (step S6). Necessary information reproduction actually starts (step S7).

During reproduction of information, whether the reproducing operation is stopped or not is always monitored (step S8). When the reproduction operation is stopped (YES in step S8), the operation is stopped as it is. On the other hand, when the operation is continued (NO in step S8), the program returns to the step S4 and the subsequent processes are repeated.

On the other hand, when it is determined in step S4 that the track search operation is performed (YES in step S4), if the determination in the step S4 is executed immediately after the operation in the step S3 or executed after the operations in steps S9 to S11 which will be described later and the tracking servo loop is continuously in the open state, the liquid crystal panel 3 is driven with the drive voltages (as described in step S2) (step S9). Further, the tracking servo loop remains in the open state (step S10) and a necessary track search is performed (step S1). The program returns again to the step S4, and the subsequent processes are repeated.

On the other hand, when the determination in the step S4 is executed after the operations in the steps S5 to S8 are performed at least once and the tracking servo loop remains in the closed state by the operation in the step S5, the drive voltages applied to the partial electrodes 30A to 30D are set as drive voltages applied when the tracking servo loop is open (in the case shown in FIG. 10, the drive voltage applied to the partial electrodes 30A and 30C is “Va_open”, the drive voltage applied to the partial electrodes 30B and 30D is “Vb_open”, and the drive voltage applied to the partial electrode 30E is “Vc”) and the liquid crystal panel 3 is driven with the set drive voltages (step S9). After that, the tracking servo loop is opened (step S10), a necessary track search is performed (step S1), the program returns again to the step S4, and the following processes are repeated.

Finally, the process for determining the values of the drive voltages shown in FIG. 10 will be described with reference to FIG. 13.

Concrete values of the drive voltages are determined, for example, at the time of shipment from a manufacturing factor of the optical pickup PU or turn-on of the power of a product including the optical pickup PU, using a jitter included in an output signal output from the detector D, error rate, or the like.

Specifically, as shown in FIG. 13A, in the case of obtaining the drive voltage (Va_close or Vb_close in FIG. 10) used for recording/reproducing the information as shown in FIG. 13A, the drive voltage to be calculated is set to the initial value (step S20), next, the amplitude of an output signal output from the detector D with the drive voltage is measured for one rotation or more of the optical disk DK (step S21). Whether the measurement value becomes the upper limit value of the output signal or not is determined (step S22). When the measurement value becomes the upper limit value (YES in step S22), the value of the drive voltage is stored as the value of the drive voltage used at the time of recording/reproducing the information, into a not-shown memory in the liquid crystal panel control unit 8 (step S24).

On the other hand, when it is determined in step S22 that the measurement value at that time is not the upper limit value (NO in step S22), the drive voltage is increased only by a preset unit amount (step S23), the program returns again to step S21, and repeats the following processes.

By performing the operation shown in FIG. 13A, the drive voltages used at the time of recording/reproducing the information are determined.

Next, in the case of determining the drive voltage (Va_open or Vb_open in FIG. 10) used for the track search, as shown in FIG. 13B, first, the focus servo loop is closed (step S30). Next, the drive voltage to be calculated is set to the initial value (step S31). After that, the track search operation is actually performed by using the set drive voltage to measure the track crossing noise (step S32). A check is made to see whether the value of the drive voltage when the measurement value is obtained becomes the upper limit value of the drive voltage or not (step S33). When the value of the drive voltage becomes the upper limit value YES in step S33), the value of the drive voltage when the value of track crossing noise is the smallest among the drive voltages is stored as the value of the drive voltage for the track search in a not-shown memory in the liquid crystal panel control unit 8 (step S35).

On the other hand, when it is determined in step S33 that the drive voltage at that time is not the upper limit value (NO in step S33), the drive voltage is increased only by a preset unit amount (step S34), and the program returns again to step S32 and repeats the following processes.

By performing the operations shown in FIG. 13B, the drive voltage used for the track search is determined.

In the case where the optical pickup PU of the embodiment is assembled in the information recording apparatus, as shown in FIG. 14, the light source 1 in the optical pickup PU is driven by a drive signal S1d obtained by modulating recording information Sr to be recorded in a recording processing unit 20, thereby recording information corresponding to the recording information Sr onto the optical disk DK.

In the case where the optical pickup PU is assembled in the information reproducing apparatus, as shown in FIG. 15, the intensity of the light beam B output from the light source 1 is made constant. Further, by performing a necessary decoding process or the like in a reproduction processing unit 40 as reproducing means on a detection signal Sp (as a sum of light reception signals of the division detectors constructing the detector D) from the detector D in the optical pickup PU, the reproduction signal Sout corresponding to information recorded on the optical disk DK is obtained.

As described above, by the operation of the optical pickup PU of the embodiment, the state of the tracking servo is switched so as to correct the astigmatism caused by the manufacture error to improve the recording/reproducing characteristic when the tracking servo loop is closed and so as to correct the track crossing noise caused when the tracking servo loop is open. In particular, the track crossing noise which occurs in the case where the tracking servo loop is open is effectively corrected as a whole, so that so-called track search operation can be performed accurately.

When the tracking servo loop is closed, that is, when information is recorded/reproduced to/from the optical disk DK, the astigmatism by a cause peculiar to the optical system is corrected. Thus, the information can be recorded/reproduced accurately.

Further, the track crossing noise is corrected generally by generation of cancellation aberration, and the correction can be easily and effectively performed.

Further, by sharing the single liquid crystal panel 3 and generating pseudo astigmatisms, the optical pickup PU can be miniaturized as a whole.

Since the amount of the pseudo astigmatism generated in the light beam B is changed by switching the pre-stored drive voltage in accordance with the kind of the optical disk DK, the track crossing noise of the amount which varies among the kinds of the optical disk DK can be corrected with simple configuration and control.

Further, information can be recorded/reproduced accurately, and occurrence of the track crossing noise in the track search operation executed in a state where the tracking servo is executed in the open state an be also effectively corrected.

By recording the program corresponding to the flowchart shown in FIG. 12 on an information recording medium such as a flexible disk or hard disk or obtaining the program via the Internet or the like and recording the obtained program, reading it, and executing it by a general computer, the computer can be used as the liquid crystal panel control unit 8.

1. An optical pickup for emitting a light beam to an optical recording medium in which recording tracks having a land/groove structure are formed and receiving reflection light from the optical recording medium of the emitted light beam, comprising:
first correcting device for correcting astigmatism included at least in the reflection light caused by a cause peculiar to an optical system as a component of the optical pickup in a state where tracking servo is on, the tracking servo for controlling a position on the optical recording medium, of a light spot formed on the recording track by the emission of the light beam and a position of the recording track;
second correcting device, when the tracking servo is off, for correcting the astigmatism and cancelling out noise included in the reflection light and received caused by the difference between a phase distribution in the light spot on the land and the phase distribution on the groove when the light spot continuously moves across the land and the groove; and
control device for operating the first and second correcting device while making a switch between the first and second correcting device in accordance with the state of the tracking servo.

2. The optical pickup according to claim 1, wherein
the first correcting device has first aberration generating device for generating, in the light beam, first cancellation aberration for cancelling out the astigmatism,
the second correcting device has second aberration generating device for generating, in the light beam, second cancellation aberration for cancelling out the astigmatism and the noise,
in the on state, the control device controls the first correcting device so as to correct the astigmatism by generating the first cancellation aberration in the light beam by the first aberration generating device and,
in the off state, the control device controls the second correcting device so as to correct the astigmatism and the noise by generating the second cancellation aberration in the light beam by the second aberration generating device.

3. The optical pickup according to claim 2, wherein the first aberration generating device and the second aberration generating device share single liquid crystal aberration generating device for generating either the first or second cancellation aberration in the light beam passing.

4. The optical pickup according to claim 2, further comprising drive information storing device for storing second drive information for driving the second aberration generating device, the second drive information varying according to kinds of the optical recording medium,
wherein the control device generates the second cancellation aberration in the light beam by switching the second drive information used for driving of the second aberration generating device in accordance with the kind of the optical recording medium to drive the second aberration generating device.

5. The optical pickup according to claim 4, wherein the drive information storing device pre-stores also first drive information for driving the first aberration generating device and peculiar to the optical system and,
in the on state, the control device drives the first aberration generating device by using the stored first drive information, thereby generating the first cancellation aberration in the light beam.

6. An information recording device for optically recording recording information on the optical recording medium in claim 1, comprising:
the optical pickup according to claim 1;
servo control device for turning on the tracking servo; and
modulating device for modulating the light beam in the on state in correspondence with the recording information and emitting the modulated light beam to the light recording medium.

7. An information reproducing device for optically reproducing reproduction information recorded on the optical recording medium in claim 1, comprising:
the optical pickup according to claim 1;
servo control device for turning on the tracking servo; and
reproducing device for receiving the reflection light of the light beam in the on state emitted to the optical recording medium and reproducing the reproduction information.

8. An aberration correcting method executed in an optical pickup of emitting a light beam to an optical recording medium in which recording tracks having a land/groove structure are formed and receiving reflection light from the optical recording medium of the emitted light beam, comprising:
a first correcting step of correcting astigmatism included at least in the reflection light caused by a cause peculiar to an optical system as a component of the optical pickup in a state where tracking servo is on, the tracking servo for controlling a position on the optical recording medium, of a light spot formed on the recording track by the emission of the light beam and a position of the recording track; and
a second correcting step of correcting the astigmatism when the tracking servo is off, and cancelling out noise included in the reflection light and received due to the difference between a phase distribution in the light spot on the land and a phase distribution on the groove when the light spot continuously moves across the land and the groove.

9. An information recording method for optically recording information on the optical recording medium in claim 8, wherein in the case of recording the recording information onto the optical recording medium,
a servo-on control step of turning on the tracking servo,
the first correcting step in claim 8, and
a modulating step of modulating the light beam in the on state in correspondence with the recording information and emitting the modulated light beam to the optical recording medium are executed, and
in the case of executing a track search for retrieving the recording track on the optical recording medium,
a servo-off control step of turning off the tracking servo, the second correcting step in claim 8, and
a search step of executing the track search during execution of the second correcting step are executed.

10. An information reproducing method for optically reproducing reproduction information recorded on the optical recording medium in claim 8, wherein in the case of reproducing the reproduction information from the optical recording medium,
a servo-on control step of turning on the tracking servo,
the first correcting step in claim 8, and
a reproducing step of receiving the reflection light of the light beam in the on state reflected by the optical recording medium and reproducing the reproduction information are executed, and
in the case of executing a track search for retrieving the recording track on the optical recording medium,
a servo-off control step of turning off the tracking servo,
the second correcting step in claim 8, and
a search step of executing the track search during execution of the second correcting step are executed.

11. An optical pickup program for making a control computer included in the optical pickup according to claim 1 function as the control device in claim 1.

12. An information recording program for making a recording computer included in the information recording device in claim 6 function as:
the control device as a component of the optical pickup of claim 6;
the servo control device; and
the modulating device.

13. An information reproducing program for making a reproduction computer included in the information reproducing device in claim 7 function as:
the control device as a component of the optical pickup of claim 7;
the servo control device; and
the reproducing device.

14. An information recording medium on which the optical pickup program of claim 11 is recorded so that it can be read by the control computer.

15. An information recording medium on which the information recording program of claim 12 is recorded so that it can be read by the recording computer.

16. An information recording medium on which the information reproduction program of claim 13 is recorded so that it can be read by the reproduction computer.
